(19) United States
(12) Patent Application Publication
(10) Pub. No.: US 2026/0291246 A1
(43) Pub. Date: Sep. 24, 2026

(54) METHODS AND APPARATUS FOR USE WITH ELECTRIC VEHICLES

(71) Applicant: ENPHASE ENERGY, INC., Petaluma, CA (US)

(72) Inventors: Raghuveer R. BELUR, Los Altos, CA (US); John Scott BERDNER, Grass Valley, CA (US)

(21) Appl. No.: 19/475,305

(22) PCT Filed: Apr. 18, 2024
(86) PCT No.: PCT/US2024/025143

§ 371 Date: Oct. 14, 2025

Related U.S. Application Data
(60) Provisional application No. 63/460,943, filed on Apr. 21, 2023.

(51) Int. Cl. H02J 3/32; B60L 53/20; B60L 53/62; B60L 53/63; B60L 53/66; B60L 53/68; B60L 55/00; H02J 3/00; H02J 13/12; H02J 105/12; H02J 105/37

(52) U.S. Cl. CPC H02J 3/322; B60L 53/20; B60L 53/62; B60L 53/63; B60L 53/66; B60L 53/68; B60L 55/00; H02J 3/003; H02J 3/004; H02J 13/12; H02J 2105/12; H02J 2105/37

(57) ABSTRACT

An electric vehicle supply equipment system for electric vehicle charging/discharging is provided and comprises an electric vehicle supply equipment that is connectable to a distributed energy resource for charging/discharging a battery of an electric vehicle and a controller in operative communication with at least one of a communication network, an electronic device of the electric vehicle, or a distributed energy resource controller for transmitting and receiving electric vehicle supply equipment information that provides the EVSE with a capability to directly (e.g., using current measurement inputs) or indirectly (e.g., using communication protocols to a remote measurement device) measure a net current being imported from or exported to a grid. Thereafter, the EVSE can use one or more control systems (e.g., an integral power control system (PCS)) to increase and/or decrease the charging and/or discharging rate of the EV to prevent overload of a service transformer.

### BACKGROUND

### Field of the Disclosure

Embodiments of the present disclosure relate generally to methods and apparatus configured for use with electric vehicles, and, for example, to electrical vehicle supply equipment (EVSE) configured to increase or decrease a charging and/or discharging rate of electric vehicles (EV) to prevent overload of a service transformer.

### Description of the Related Art

EVs are a mobile distributed energy resource, e.g., mobile storage. The EVs can be charged from a grid, from private energy sources (e.g., photovoltaics (PV), and energy storage systems (stationary)), or from a public energy source (e.g., EVSE). Additionally, EV chargers are increasing in size and are now reaching a point where the EV chargers can trigger an upgrade of a utility service transformer. For example, General Motors (GM) has recently officially announced that the Silverado® pickup will now ship with a 19.2 kW EV charger, which is significantly larger than many residential service transformers (e.g., 10 kW or 15 kW are common). Thus, utilities will require a service transformer to be upgraded to meet increased demand.

Thus, the inventors describe herein an improved (EVSE) configured to increase or decrease a charging and/or discharging rate of electric vehicles (EV) to prevent overload of a service transformer.

### SUMMARY

In accordance with at least some aspects of the present disclosure there is provided an electric vehicle supply equipment (EVSE) system for electric vehicle (EV) charging/discharging. The EVSE system comprises an EVSE connectable to a distributed energy resource for charging/discharging a battery of an EV and a controller in operative communication with at least one of a communication network, an electronic device of the EV, or a distributed energy resource controller and configured to transmit and receive EVSE information that provides the EVSE with a capability to directly or indirectly measure a net current being imported from or exported to a grid.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIG. 2 is a diagram of an EVSE system that is configured to connect to the energy management system of FIG. 1, in accordance with one or more embodiments of the present disclosure;

FIG. 3 is a diagram of system configured for use with the energy management system and the EVSE system of FIG. 1 and FIG. 2, respectively, in accordance with one or more embodiments of the present disclosure; and

FIG. 4 is a diagram of a system and a dynamic profile configured for use with the energy management system and the EVSE system of FIG. 1 and FIG. 2, respectively, in accordance with one or more embodiments of the present disclosure.

### DETAILED DESCRIPTION

Embodiments of the present disclosure provide improved electrical vehicle supply equipment (EVSE) configured to increase or decrease a charging and/or discharging rate of electric vehicles (EV) to prevent overload of a service transformer. For example, the inventive concepts described herein provide remote current sensing capabilities to an EVSE (e.g., an EV Charger) and power control system functionality to the EVSE, as described in greater detail below. For example, the EVSE described herein provide the EVSE with a capability to directly (e.g., using current measurement inputs) or indirectly (e.g., using communication protocols to a remote measurement device) measure a net current being imported from or exported to a grid. Thereafter, the EVSE can use one or more control systems (e.g., an integral power control system (PCS)) to increase and/or decrease the charging and/or discharging rate of the EV to prevent overload of a service transformer. The methods and apparatus described herein allow relatively large EV chargers to charge and/or discharge using residential service transformers (e.g., 10 kW or 15 kW is common) without having a utility to upgrade a service transformer to meet increased demand.

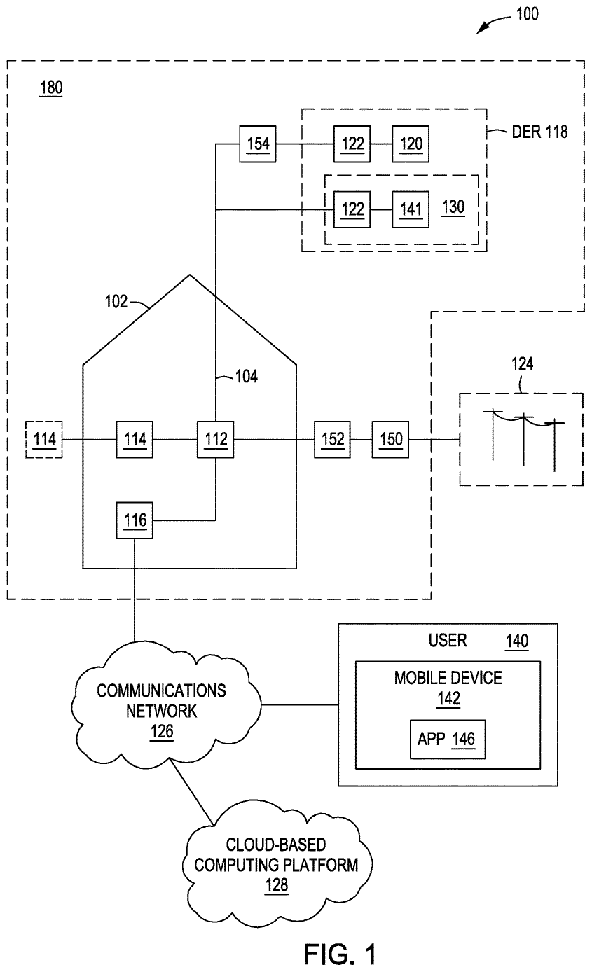

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home, commercial building, or separate mounting structure, having an associated DER 118 (distributed energy resource). The DER 118 is situated external to the structure 102. For example, the DER 118 may be located on the roof of the structure 102 or can be part of a solar farm. The structure 102 comprises one or more loads and/or energy storage devices 114 (e.g., appliances, electric hot water heaters, thermostats/detectors, boilers, electric vehicle supply equipment (EVSE), water pumps, and the like), which can be located within or outside the structure 102, and a DER controller 116, each coupled to a load center 112 (e.g., a main panel). Although the energy storage devices 114, the DER controller 116, and the load center 112 are depicted as being located within the structure 102, one or more of these may be located external to the structure 102.

The load center 112 is coupled to the DER 118 by an AC bus 104 and is further coupled, via a meter 152 and optionally a MID 150 (microgrid interconnect device or intertie), to a grid 124 (e.g., a commercial/utility power grid that comprises a transformer, such as a common/shared service transformer). The structure 102, the energy storage devices 114, DER controller 116, DER 118, load center 112, generation meter 154, the meter 152, and the MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a corresponding battery may be referred to as an AC battery.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the energy storage devices 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output. Any AC to DC device which is configured to convert AC generated from renewable sources to DC can be used for charging an EV, e.g., a bidirectional inverter such as a simple charger onboard an EV. A key aspect of the present disclosure is the ability of measuring the energy (AC or DC) supplied to an EV battery.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method that provides the EVSE with a capability to directly (e.g., using current measurement inputs) or indirectly (e.g., using communication protocols to a remote measurement device) measure a net current being imported from or exported to a grid. Thereafter, the EVSE can use one or more control systems (e.g., an integral power control system (PCS)) to increase and/or decrease the charging and/or discharging rate of the EV to prevent overload of a service transformer, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage. The meter 152 measures power flows independently of MID state, i.e., when MID is closed and DER's are connected to the grid and when MID is open and DER's are isolated from the grid.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (an application 146)) installed thereon for controlling the connectivity with the grid 124 as described herein. The may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

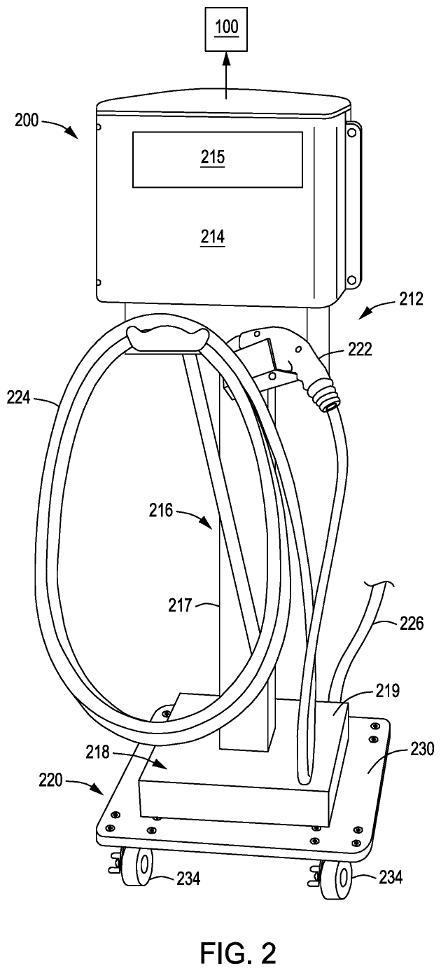

FIG. 2 is a diagram of an EVSE system (a system 200) , in accordance with one or more embodiments of the present disclosure. As shown in FIG. 2, the system 200 is configured to connect to the system 100 and comprises electric vehicle supply equipment 212, a housing enclosure 214, a pedestal 216 having a base 218, and a transport module 220 coupled to the base 218. The electric vehicle supply equipment 212 can include an electric vehicle connector 222, which can comprise a cord 224, configured for connection to an electric vehicle inlet (not shown). The electric vehicle supply equipment 212 can include a service entrance cable 226 configured to connect, for example, to the load center 112 wiring to deliver energy to the electric vehicle connector 222. The electric vehicle supply equipment 212 can include a controller 215 (e.g., similar to the DER controller 116) which can be housed in the housing enclosure 214. The electric vehicle supply equipment 212 can also include ungrounded, grounded, and equipment grounding conductors, attachment plugs, and other fittings, devices, power outlets, or apparatuses necessary to deliver energy from the premises wiring (not shown) to an EV (not shown), all or a portion of which may be enclosed within housing enclosure 214. The pedestal 216 is coupled to and supports the housing enclosure 214 and may include a hollow tubular portion 217 and a base 218. The base 218 may include a base cover 219 and a base plate (not shown) configured to engage and be supported on a top surface of the transport module 220. The transport module 220 comprises a platform 230 that is configured to support the base 218, and wheels 234 are provided on the platform 230 to facilitate moving the system 200 when not connected to the system 100.

The electric vehicle supply equipment 212 (including electric vehicle connector 222, cord 224, and service entrance cable 226), the housing enclosure 214, and the pedestal 216 (including hollow tubular portion 217 and base 218), may be a commercially available electric vehicle charge station such as, for example but not limited to, a CS Series Public EVSE provided by ClipperCreek, Inc. of Auburn, Calif.

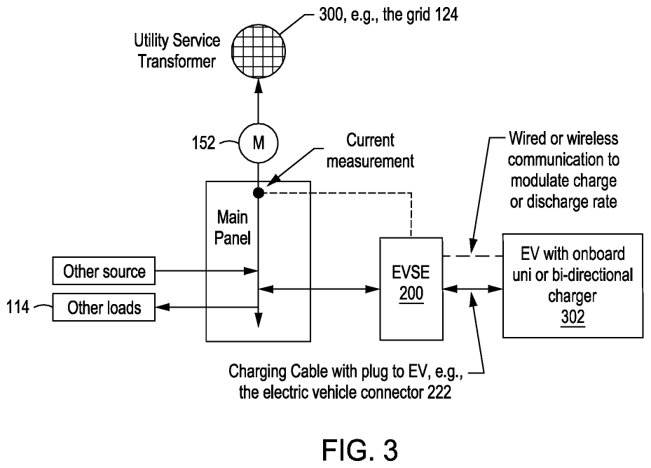

As described above, inventive concepts described herein provide the EVSE with a capability to directly (e.g., using current measurement inputs, such as from a current transformer connected between the load center 112 and the system 200) or indirectly (e.g., using communication protocols to a remote measurement device) measure a net current being imported from or exported to a grid. For example, FIG. 3 is a diagram of a system configured for use with the energy management system and the EVSE system of FIG. 1 and FIG. 2, respectively, in accordance with one or more embodiments of the present disclosure. For illustrative purposes, the methods and apparatus disclosed herein are described in terms of use with a 15 kW transformer. The methods and apparatus disclosed herein, however, can be equally used with transformers with larger or smaller power rating based on what the site or collection of sites drawing power from that transformer can handle, which may be based on utility limitations, in some embodiments based on transformer size, local production and/or consumption estimates, other network capacity or production and/or consumption estimates, substation capacity, generation or feeder network capacity, or other grid conditions or estimates. Utility limitations may be reflected in a dynamic profile (or curve) that is, again, transformer-based or site-based. The curve directly impacts the import/export limitations of each particular site, which may be taken one site at a time or which may be negotiated amongst two or more of the total number of sites. Some considerations or the negotiation amongst the sites can include, but are not limited to, pricing, need for power, production and/or consumption estimates, and other factors.

In at least some embodiments, the inventive concepts can be used for EV charging (e.g., normal EV charging only). For example, a controller in operative communication with at least one of a communication network, an electronic device of the EV, or a DER controller can be configured to transmit and receive EVSE information that provides the EVSE with a capability to directly or indirectly measure a net current being imported from or exported to a grid. For example, an EV 302 can be configured to import up to 19.2 kW from the grid 124 (e.g., a service transformer 300). The PCS (e.g., the controller 215 of the system 200), however, is limited to charging up to 15 kW (e.g., assuming no other loads are on in the home). If one or more of the loads (e.g., an HVAC) in the home, however, turns on and, for example, draws 5 kW, the PCS would reduce charging limit to 10 kW (15 kW net from the grid). A homeowner's PV system is putting out 7 kW, so the PCS would increase charging limit up to full 19.2 kW since the PV is providing some of the charging (e.g., 19.2 kw charge−7 kW from PV=12.2 kW, which is less than the 15 kW rating of the service transformer 300). Accordingly, the PV provides 7 kW and the HVAC is drawing 5 kW, which is >> than PCS limits charger to 17 kW to keep net power below 15 kW rating.

In at least some embodiments, the inventive concepts can be used for EV discharging (e.g., bidirectional EV charger). For example, the EV 302 is configured to export up to 19.2 kW to the grid 124. The PCS, however, is limited to discharging up to 15 kW (e.g., assuming no other loads are on in the home). If one or more of the loads (e.g., an HVAC) in the home, however, turns on and, for example, draws 5 kW, the PCS would allow full 19.2 kW discharging since 19.2 kW−5 kW=14.2 kW, which is less than the service transformer 300 rating. A homeowner's PV system is putting out 7 kW, so PCS would decrease discharging limit to 8 kW since the PV is also exporting to the grid (e.g., 7 kW (PV)+8 kW (EV)=15 kW rating of the service). Accordingly, the PV provides 7 kW and the HVAC is drawing 5 kW, which is >> PCS limits discharge to 13 kW to keep net power below 15 kW rating.

Thus, the PCS is configured to dynamically adjust the EV charging and/or discharging rates in response to changes in other loads or changes in output of other onsite generation resources to prevent overload of service transformers. Additionally, the PCS may dynamically adjust the EV charging and/or discharging rates below those needed to prevent overload of the utility service transformer in response to economic signals, such as time of use rates or other dynamic utility tariff structures. The PCS is configured to modulate the EV charging and/or discharging behaviors with sufficient speed to meet local utility requirements for response times.

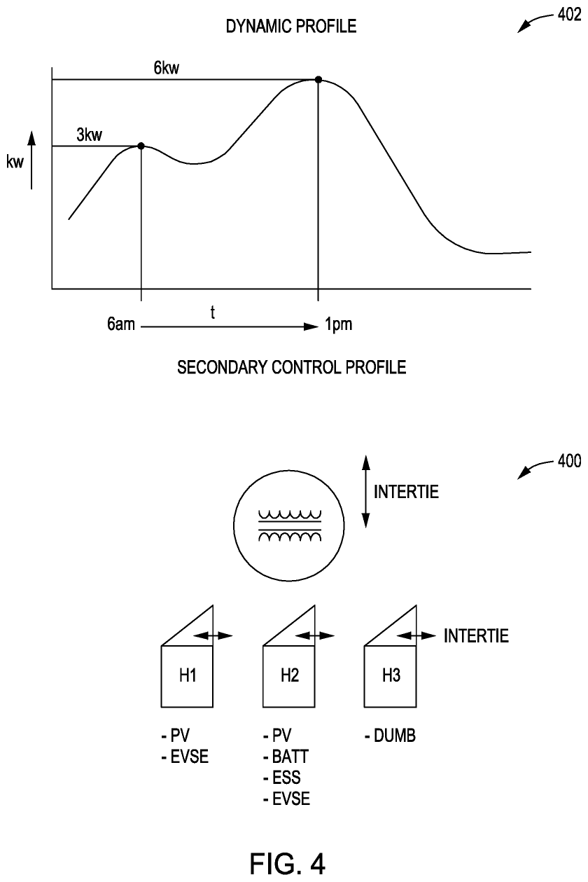

FIG. 4 is a diagram of a system 400 and a dynamic profile 402 configured for use with the system 100 and the system 200 of FIG. 1 and FIG. 2, respectively, in accordance with one or more embodiments of the present disclosure. For example, in at least some embodiments, the PCS of the EVSE (or other DER, e.g., PV, Battery, energy storage system (ESS)) can be configured to dynamically adjust/change (e.g., via dynamic profiling software, such as non-transitory computer readable storage medium) the EV charging/discharging rates based on multiple homes (e.g., smart homes, H₁ and H₂) connected to a common/shared service transformer (e.g., an allocation of how much of the service transformer 300 each home of the multiple homes can use). For example, resources (loads) in a first home may be required/need to absorb a certain amount of kW at a particular time during a day (e.g., 3 kW at 6 am and 6 kW at 1 pm, see dynamic profile 402), which can change from day to day, week to week, year to year, etc. The PCS can be configured to monitor the resources that are in the first home to steer/control the charging/discharging of the resources in the first home and monitor the resources in one or more other homes (e.g., a second home and a third home) connected to the common transformer. The PCS can forecast production/consumption of the resources in the first home, second home, and third home. For example, the PCS can control production for a battery in the first home, can control consumption of an AC in the second home, and consumption of a hot water heater in the third home. As can be appreciated, the PCS would not be able to directly control production/consumption of the resources in non-compatible homes (e.g., dumb homes, such as H3), but, nonetheless, the non-compatible homes would still benefit from the methods described herein, as described in greater detail below.

In other embodiments, the PCS may be configured to control production/consumption of the resources based on other factors. For example, a limiting factor may be something other than transformer capability (e.g., utility restriction, generation restriction, substation restriction, network restriction, etc.). For example, the utility can indicate to the PCS that there is a fixed variant or time variant constraint of a utility asset, e.g., downstream of a choke point, so that the PCS can charge the EV within the utility limits, which can be performed 24/7. That is, the PCS can be configured to receive from the utility dynamic physical layer constraints (e.g., capacity constraint, frequency constraint, infrastructure constraint, etc.) pertaining to what can go in and out of a home, e.g., secondary control of the PCS based on the dynamic profile of the home.

Additionally, for economic optimization, the PCS can be configured for tertiary control. For example, even though a dynamic profile may indicate that the PCS can export 3 kW to the grid, the PCS may determine based on a pricing scenario/signal, which can be received from the utility, that it is not advantageous to do so at that time, e.g., hold on to stored energy of the EV battery. That is, the PCS can provide monetary balancing due to varying and sometimes dynamic tariffs.

In at least some embodiments, each home of the plurality of homes can have a unique control home profile. Accordingly, the PCS can construct the dynamic profile of the plurality of homes to help the utility by making a collective decision across the common transformer. For example, in at least some embodiments, the first home can be partially intelligent, the second home can be very intelligent, and the third home can be dumb. Thus, by constructing and using the PCS dynamic profile, the PCS can provide a greater benefit for the third home. For example, the first home and the second home can have two or three EV chargers, which would cause the utility to upgrade the common transformer to meet the demands of the EV chargers. Conventionally, the third home would be accessed with the costs associated for upgrading the transformer. In accordance with the PCS dynamic profile described herein, however, the need for upgrading the transformer would be eliminated.

In at least some embodiments, the PCS can wirelessly (or wired) communicate with the transformer and/or the utility to determine a actual/total load on the transformer. In at least some embodiments, one or more sensors (e.g., with a small Wi-Fi transmitter) can be provided at the transformer so that all PCSs in operative communication with the transformer (e.g., registered with the transformer) can know the actual load on the transformer. Alternatively, the PCS can be configured to communicate with a smart meter when such an option is available to the PCS. For example, five homes can share a common transformer and the utility allocates twenty percent of the transformer to each of the five homes, and two of the homes have solar and storage and are not using their entire allocation, that unused allocation can be reallocated by the PCS to the dumb homes dynamically so that the dumb homes can have a greater allotment of the transformer. Similarly, if the transformer is low, instead of getting the twenty percent allocation, the PCS can charge/export more based on the actual transformer load. Accordingly, the PCS can use the transformer consumption profile and, in conjunction the individual home profiles, can optimize the performance of the transformer and, ultimately, make the grid more efficient and less expensive.

While the foregoing is directed to embodiments of the present disclosure, other and further embodiments of the disclosure may be devised without departing from the basic scope thereof, and the scope thereof is determined by the claims that follow.

1. An electric vehicle supply equipment (EVSE) system for electric vehicle (EV) charging/discharging comprises:
an EVSE connectable to a distributed energy resource for charging/discharging a battery of an EV; and
a controller in operative communication with at least one of a communication network, an electronic device of the EV, or a distributed energy resource controller and configured to transmit and receive EVSE information that provides the EVSE with a capability to directly or indirectly measure a net current being imported from or exported to a grid.

2. The EVSE system of claim 1, wherein the controller is further configured to use a current measurement input to directly measure the net current being imported from or exported to the grid.

3. The EVSE system of claim 1, wherein the current measurement inputs are provided by a current transformer disposed in a load center.

4. The EVSE system of claim 1, wherein the controller is further configured to use communication protocols to a remote measurement to indirectly measure the net current being imported from or exported to the grid.

5. The EVSE system of claim 1, wherein the EVSE is in operative communication with the EV via one of wired or wireless communication for controlling a charging/discharging rate of the EV.

6. The EVSE system of claim 1, wherein the EV is configured to import and export about 19 kW from the grid.

7. The EVSE system of claim 1, wherein the EVSE is in operative communication with a transformer of the grid via one of wired or wireless communication for controlling a charging/discharging rate of the EV.

8. The EVSE system 7 claim 1, wherein the controller is further configured to dynamically adjust/change, via dynamic profiling software, a charging/discharging rate of the EV based on multiple homes connected to a common transformer of the grid.

9. The EVSE system of claim 1, wherein the controller is further configured to monitor one or more resources in a first home to steer/control charging/discharging of the one or more resources in the first home and monitor one or more resources in one or more other homes connected to a common transformer of the grid.

10. The EVSE system of claim 9, wherein the controller is further configured to forecast production/consumption of the one or more resources in the first home and one or more resources in the one or more other homes.

11. The EVSE system of claim 9, wherein the controller is further configured to control production/consumption of the one or more resources in the first home and the one or more resources in the one or more other homes based on at least one of a utility restriction, generation restriction, substation restriction, or network restriction.

12. The EVSE system of claim 11, wherein the utility restriction comprises at least one of a fixed variant or time variant constraint that allows the controller to charge the EV within utility limits.

13. The EVSE system of claim 12, wherein the controller is further configured to receive, from a utility, dynamic physical layer constraints comprising at least one of a capacity constraint, a frequency constraint, or an infrastructure constraint that pertains to energy going in and out of the home or the other homes.

14. The EVSE system of claim 1, wherein the electronic device of the EV is at least one of a uni-directional or bi-directional converter.

15. An energy management system, comprising:
a distributed energy resource;
a distributed energy resource controller configured to provide operative control of the distributed energy resource and/or receive data or information from the distributed energy resource; and
an electric vehicle supply equipment (EVSE) system for electric vehicle (EV) charging/discharging, comprising:
an EVSE connectable to the distributed energy resource for charging/discharging a battery of an EV; and
a controller in operative communication with at least one of a communication network, an electronic device of the EV, or the distributed energy resource controller and configured to transmit and receive EVSE information that provides the EVSE with a capability to directly or indirectly measure a net current being imported from or exported to a grid.

16. The energy management system of claim 15, wherein the controller is further configured to use a current measurement input to directly measure the net current being imported from or exported to the grid.

17. The energy management system of claim 15, wherein the current measurement inputs are provided by a current transformer disposed in a load center.

18. The energy management system of claim 15, wherein the controller is further configured to use communication protocols to a remote measurement to indirectly measure the net current being imported from or exported to the grid.

19. The energy management system of claim 15, wherein the EVSE is in operative communication with the EV via one of wired or wireless communication for controlling a charging/discharging rate of the EV.

20. The energy management system of claim 15, wherein the EV is configured to import and export about 19 kW from the grid.
